(19) United States
(12) Patent Application Publication
(10) Pub. No.: US 2015/0271596 A1
(43) Pub. Date: Sep. 24, 2015

(54) Independent Smart Headset with a Host Releasably Attached Via Magnet Attraction

(71) Applicant: ChangZhou Xing Ju Network Technology Co., Ltd., Changzhou City (CN)

(72) Inventor: Ge CHEN, Beijing (CN)

(73) Assignee: ChangZhou Xing Ju Network Technology Co., Ltd.

(21) Appl. No.: 14/570,707

(22) Filed: Dec. 15, 2014

(30) Foreign Application Priority Data
Mar. 18, 2014 (CN) 201410100082.7

(51) Int. Cl. H04R 3/00

(52) U.S. Cl. CPC H04R 3/00; H04R 2420/07

(57) ABSTRACT

The present invention relates to an independent smart headset apparatus with a host releasably attached via magnet attraction. The apparatus may comprise of smart host and headset portions. The host can include a pair of magnet contacts and four metal wafers. The headset portion can include an earshell which is provided with a pair of magnet contacts corresponding to the pair of magnets included in the host. The earshell can also include four metal styluses corresponding to the four metal wafers included in the host. The independent smart headset apparatus constitutes a single device with the host and the headset that releasably and magnetically attach to one another without affecting data transmission between the two portions. The present invention overcomes the complexities associated with human-computer interaction and provides a convenient platform on which to listen to music and engage in online messaging and social activities.

### FIELD OF INVENTION

The present invention relates to an independent, stand-alone, smart headset with a smart host releasably attached to the smart headset, via magnet attraction.

### BACKGROUND

Currently, listening to music via a headset needs a headset device, a music-playing device, and an audio cable device connecting the headset to the music-playing device; or alternatively, the headset and the music playing device may be provided with a wireless data exchange technology module, such as a Bluetooth® technology module, through which the headset may be connected to the music-playing device. In both ways, the user may operate the music-playing device to play music. The headset is utilized as an accessory, and listening to music via a headset requires three independent devices: a headset, an audio cable and a music-playing device. Existing headsets cannot play music independently, which render current music device—headset combinations cumbersome and costly. There is a need for new and improved headset devices.

### SUMMARY OF INVENTION

Smart headset of the present invention is defined as a type of headset that incorporates smart headset technology analogous to that of a smartphone. Likewise, smart host as described in the invention refers to a device that fits into an earshell of the headset which utilizes user interface technologies similar to that of a smartphone. Currently, there are few, if any, smart headsets. With the independent (i.e. stand-alone) smart headset apparatus with a smart host portion releasably attached to a headset portion via magnet attraction of the present invention, a completely independent networked device may be realized. In this way, the smart host and the headset may readily attach and detach from each other without affecting data transmission between the two components. This is an improvement over currently known headset devices where playing music, messaging and socializing have conventionally required a headset device in combination with another external device such as the cellular phone, tablet, or other audio playing device. The present invention simplifies human-computer interaction, realizes online or offline music playing and online messaging and socializing at any time and at any place.

In order to achieve the aforementioned aim, there is provided in an embodiment of the present invention, an independent smart headset apparatus with a smart host releasably attached via magnet attraction, and said independent smart headset includes a smart host and a headset portions.

In an embodiment, the smart host portion can be an electronic component including a printed circuit board, such as printed circuit board assembly (PCBA) board, a tactile sensor such as touchpad (TP) board, a user interface such as light-emitting diode (LED) screen, a power source such as a battery, an insertion slot for a type of removable card device such as a Micro card slot, an interface for communication and power supply between computers and electronic devices such as an industry standard Micro USB interface, and physical function keys or buttons.

In an embodiment, the PCBA board may be embedded with a memory card such as an 8 gb memory card in a removable memory card insertion slot, a wireless (3G) module, a local area wireless technology module such as WiFi or wireless local area network (WLAN) module, and a wireless data exchange technology module, such as a Bluetooth® module.

In an embodiment, the back of the smart host is provided with two magnet contacts: a magnet contact A, and a magnet contact B; the back of the smart host is also provided with four metal wafers a, b, c, d.

In an embodiment, the headset portion can include a touchpad, a wireless technology standard module, such as a Bluetooth® module, a battery, a left earshell, a right earshell, a microphone (MIC), and an audio cable interface.

The front of the right earshell is provided with two magnet contacts: a magnet contact C and a magnet contact D; the front of the right earshell is also provided with four metal styluses e, f, g, h.

The four contacts, i.e., two magnet contacts A and B on the rear portion of the smart host and the two magnet contacts C and D on the right earshell of the headset, are respectively wrapped with a magnet accumulation iron bowl. Anodes and cathodes of A and C, B and D are exchanged such that they are magnetically attracted to each other, allowing the smart host to releasably attach to the headset;

When the smart host is releasably attached to the headset, the four metal styluses e, f, g, h on the right earshell touch the four metal wafers a, b, c, d on the back of the smart host, allowing data communication between the smart host and headset portions regarding control of features such as battery power-on (BAT), ground (GND), Bluetooth® on (BT-ON), and Bluetooth® pair (BT-PAIR) of the smart host and the headset portions.

In an embodiment, the wireless technology standard module such as the Bluetooth® module in the left earshell of the headset matches the wireless module (e.g., Bluetooth®) module on the PCBA board of the smart host, allowing transmission of data and audio signals between the smart host and the headset.

The touchpad on the left earshell of the headset controls the source of audio in the smart host.

In an embodiment of the independent smart headset apparatus with a releasably attached smart host described above, the PCBA board of the smart host can be embedded with a wireless mobile telecommunications technology module, such as a 3G module, and a local area wireless technology module, such as a WiFi module, to realize an independent network connection.

In an embodiment of the independent smart headset apparatus with a releasably attached smart host described above, the smart host portion can be provided with a type of individual user identification component or subscriber identity module (SIM) data card slot. When a SIM card or data card is inserted into the slot, the smart host portion can be connected to a network via the wireless mobile telecommunications technology module such as a 3G module.

In an embodiment of the independent smart headset apparatus with a releasably attached smart host described above, the smart host portion can include a customized mobile operating system, such as an Android™ operating system to support running of software.

In an embodiment of the independent smart headset apparatus with a releasably attached smart host described above, the smart host portion can include a music and radio software applications (App), providing access to unlimited music sources.

In an embodiment of the independent smart headset apparatus with a releasably attached smart host described above, the smart host portion includes an instant messaging and online social network applications (Apps), providing an online interactive social media platform and experience.

In an embodiment of the independent smart headset apparatus with a releasably attached smart host described above, the PCBA board of the smart host portion includes a memory card, for example an 8 gb memory card, for storing and playing music.

In an embodiment of the independent smart headset apparatus with a releasably attached smart host described above, the PCBA board of the smart host portion can include a wireless signal emission module (e.g., Bluetooth®), capable of communicating with a wireless signal receiving module (e.g., Bluetooth®) of the headset portion when the smart host is activated, such that the transmission of audio data and audio signals between the smart host and the headset do not break when the smart host is separated from the headset.

### BRIEF DESCRIPTION OF DRAWINGS

The foregoing summary and detailed description can be better understood where read in conjunction with the accompanying drawings, which are included by way of example. A more detailed description of illustrative embodiments of the present invention with reference to the accompanying drawings, the above described and any other aspects and merits of the present invention is provided.

FIG. 1 is a schematic of the exploded structure of an independent smart headset with a host releasably attached via magnet attraction.

FIG. 2 is a schematic of the combinational structure of an independent smart headset with a host releasably attached via magnet attraction.

### DETAILED DESCRIPTION OF INVENTION

The present invention will now be fully described with reference to the accompanying drawings. Various embodiments are illustrated in the drawings. However, the present invention may be implemented in various forms, and shall not be interpreted as being restricted in the embodiments illustrated herein. On the contrary, the presentation of these embodiments will render the present disclosure thorough and complete, and the scope of the present invention may be fully delivered to persons skilled in the art.

Illustrative embodiments of the present invention are described with reference to the accompanying drawings.

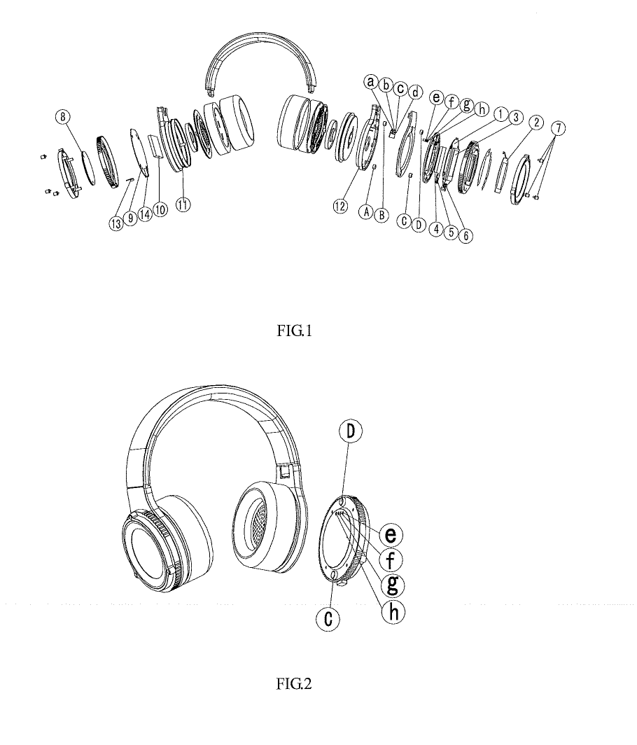

Referring to FIG. 1, an independent smart headset with a smart host releasably attached via magnet attraction is shown, which includes a smart host (a) and a headset (b).

The smart host (a) portion may comprise of a printed circuit board assembly (PCBA) board (1), a touchpad (TP) board (2), a light-emitting diode (LED) screen (3), a battery (4), a Micro card slot (5), a Micro USB interface (6), and three physical function keys (7). The PCBA board (1) is embedded with a memory card of a suitable capacity, such as 8 gb memory card, a 3G module, a WiFi module, and a Bluetooth® module. The back of the smart host is provided with a magnet contact A and a magnet contact B. The back of the smart host is also provided with four metal wafers a, b, c, d.

The headset (b) portion comprises: a touchpad (8), a Bluetooth® module (9), a battery (10), a left earshell (11), a right earshell (12), a microphone (MIC) (13), and an audio cable interface (14). The front of the right earshell is provided with four metal styluses e, f, g, h.

Four contacts, i.e. two magnet contacts A and B at the rear portion of the smart host (a), and two magnet contacts C and D on the right earshell (12) of the headset (b) are respectively wrapped with a magnet accumulation iron bowl. Anodes and cathodes of A and C, B and D are exchanged such that they are magnetically attracted to each other, allowing the smart host (a) to releasably attach to and detach from the headset (b).

When the smart host (a) is attached to the headset (b), four metal styluses e, f, g, h of the right earshell (12) contact four metal wafers a, b, c, d on the back of the smart host (a), providing control of the Battery (BAT), ground (GND), Bluetooth® on (BT-ON), Bluetooth® pair (BT-PAIR) control features which allow data communication between the smart host (a) and the headset portion (b).

Audio signal transmission between the smart host (a) and the headset (b) is realized by matching the wireless signal emission (e.g., Bluetooth®) module (9) in the left earshell (11) of the headset with the Bluetooth® module on the PCBA board (1) of the smart host (a).

The touchpad (8), which can be position on the left earshell (11) of the headset (b) can be used to control the source of audio in the smart host (a).

When a subscriber identity module (SIM) card or data card is inserted into a Micro card slot (5), the smart host (a) is automatically connected to the network via the wireless mobile telecommunications technology (e.g., 3G) module on the PCBA board (1); or the smart host (a) automatically connects to the network via a local area wireless technology module such as the WiFi module on the PCBA board (1).

The smart host (a) can include a music radio software application (App), and music may be played online or offline without limitations via the music radio application (App).

With a memory card (e.g., 8 gb memory card) embedded in the PCBA board (1), the user may store audio files via an interface for communication, power supply between computers and electronic devices such as an industry standard Micro USB interface (6), and play music via an audio playing application (App) preinstalled in the smart host (a).

For the independent smart headset with a smart host releasably attached via magnet attraction, the smart host (a) can include an instant messaging and online social applications (Apps), and when it is connected to a network, a user may easily carry out online messaging and socializing via text and voice. In an embodiment, the smart host (a) can be readily detached from the headset (b), overcoming the cumbersome interface issues associated with human-computer interaction.

For the independent smart headset with a smart host releasably attached via magnet attraction, it can be connected to other music playing devices such as a cellular phone, tablet and so forth through the audio cable interface (14) via an audio cable when the smart host (a) is shut off.

With the independent smart headset with a smart host releasably attached via magnet attraction constitutes a single device with the smart host and the headset that are magnetically and releasably attached and detached from one another without affecting data transmission. The present invention overcomes the complexities associated with human-computer interaction and realizes online or offline music listening and online messaging and socializing at any time and any place without affecting data transmission. It simplifies human-computer interaction as the user may listen to music online or offline as well as perform online messaging and socializing at any time and any place. It combines functions of a headset, cellular phone, tablet and other audio playing devices all in one. It is unique in design, low in cost, convenient in performing human-computer interaction and easy to carry.

The human-computer interaction between the independent smart headset with a smart host releasably attached via magnet attraction and its user may be operated via voice recognition control. That is to say, the user may directly send out voice commands via the microphone (MIC) (13) and the software application (App) can be automatically operated via the voice recognition function within the system, without having to detach the smart host (a) from the headphones to touch the LED screen (13) and manually operate the software application (App) preinstalled in the smart host (a) via the touchpad (TP) board (2).

With the independent smart headset with a smart host releasably attached via magnet attraction, an independent device may be automatically connected to a network and the smart host and the headset may be easily integrated and separated without affecting data transmission. It simplifies human-computer interaction and provides access to unlimited music sources. The user may be able to listen to music at any time and any place and perform online messaging and socializing simultaneously. It replaces the traditional form of listening to music, a headset with a cellular phone, tablet or other music playing devices. In addition, online messaging and social networking can occur via an independent smart headset device.

The above are exemplary embodiments of the present invention, and are not intended to limit the present invention. Various modifications and changes may be made to the present invention. Any amendments, substitutions, improvements and the like made in the spirit and principle of the present invention shall be within the scope of protection of the present invention.

What is claimed:

1. An independent smart headset apparatus with a smart host releasably attached via magnet attraction, which is composed of:
a smart host portion and a headset portion;
the smart host portion comprising: a printed circuit board, a tactile sensor board, a user interface, a power source, a memory storage device, an interface for communication and power supply, and a mechanical component;
the printed circuit board including a memory card, a wireless mobile telecommunications module, a wireless local area network module, and a wireless data exchange module;
wherein the smart host includes, a number of magnet contacts, and further includes a number of metal wafers;
the headset portion comprising: a tactile sensor device, a wireless data exchange module, a power source, a left earshell, a right earshell, a microphone, and an audio cable interface;
wherein an earshell includes a number of magnet contacts corresponding to the number of magnet contacts included in the host;
an earshell further includes a number of metal styluses corresponding to the number of metal wafers included in the host;
wherein the number of metal contacts included in the host and the corresponding number of metal contacts included in the earshell are respectively wrapped with a magnet accumulation bowl;
wherein the smart host portion is systematically integrated with the headset portion through contact between the number of metal styluses included in the earshell and the number of metal wafers included in the smart host thereby providing control of the power sources and the wireless data exchange modules included in the headset portion and the smart host portion;
wherein, the wireless data exchange module included in the earshell of the headset communicates wirelessly with the wireless data exchange module on the printed circuit board in the smart host allowing data exchange or signal transmission between the smart host and the headset;
wherein an audio source in the smart host is controlled using the tactile sensor device.

2. The independent smart headset apparatus according to claim 1, comprising:
a printed circuit board in the smart host including a wireless mobile telecommunications module and a wireless local area network module, wherein the wireless mobile telecommunications module is a 3G or 4G module and the wireless local area network module is a WiFi module.

3. The independent smart headset apparatus according to claim 1, wherein the smart host portion further includes a removable card slot, holding a type of individual user identification component card or data card, allowing the smart host portion to connect to a data network via a wireless mobile telecommunications module.

4. The independent smart headset apparatus according to claim 3, wherein the type of individual user identification component card or data card is a subscriber identity module (SIM) card.

5. The independent smart headset apparatus according to claim 1, wherein the smart host portion includes a customized mobile operating system to support running of software applications.

6. The independent smart headset apparatus according to claim 1, wherein the smart host portion includes a type of audio software application that can access online music sources.

7. The independent smart headset apparatus according to claim 1, wherein the smart host portion includes at least one of an instant messaging software application or an online social platform software application.

8. The independent smart headset apparatus according to claim 1, wherein the printed circuit board in the smart host portion includes a memory card for storing and playing music.

9. The independent smart headset apparatus according to claim 1, wherein the printed circuit board in the host portion includes a wireless data exchange module for transmission which communicates wirelessly with a wireless data exchange module for reception in the headset portion when the host is on, and maintains the transmission of data between the host and the headset.

10. The independent smart headset apparatus according to claim 8, wherein the smart host portion is detached from the headset portion and maintains the transmission of audio data between the smart host and the headset.
